(19) United States
(12) Patent Application Publication
(10) Pub. No.: US 2013/0106080 A1
(43) Pub. Date: May 2, 2013

(54) AIRBAG ARRANGEMENT FOR ANGLED AIRCRAFT SEATS

(71) Applicants: Patrick Jarboe, Davisburg, MI (US); Douglas Werth, Lake Orion, MI (US); Raj Valera, Rochester, MI (US)

(72) Inventors: Patrick Jarboe, Davisburg, MI (US); Douglas Werth, Lake Orion, MI (US); Raj Valera, Rochester, MI (US)

(21) Appl. No.: 13/284,004

(22) Filed: Oct. 28, 2011

(51) Int. Cl. B60R 21/16; B64D 25/02

(52) U.S. Cl. 280/730.2

(57) ABSTRACT

An airbag arrangement is accommodated in an armrest between angled seats. A gas generator inflates an airbag cushion in the path of inertia of each seat occupant of an angled seat. The airbag may have a lamella structure to inflate to a cushioning curtain or wall with a stiffness that resists bending and folding. The airbag may alternatively be provided with wider channels to provide a thicker cushion.

### FIELD OF THE INVENTION

The invention relates to an airbag arrangement in an aircraft for the protection of seat occupants in seats that do not face straight forward, but are arranged at an angle with respect to the forward direction of the aircraft.

### BACKGROUND OF THE INVENTION

Airbags have been credited for saving lives by damping impact of a vehicle crash on a vehicle occupant. Not only frontal airbags are in use, but also side airbags, such as curtain airbags expanding from the roof line of a vehicle or airbags arranged in a center console or armrest between two car seats. After the gas generator is triggered, the airbag unfolds and provides padding for the seat occupant. An airbag arranged in an armrest pushes itself between the seats and between seat occupants sitting next to each other. Another known airbag design provides an airbag in the vicinity of the center tunnel of the vehicle that inflates above the heads of the vehicle occupants to protect the occupants in the event of a vehicle rollover.

Airbags are designed to provide a synergetic effect with seat belts that restrain seat occupants in a defined position. At least the front seats of a vehicle and increasingly also the rear seats are provided with three-point seatbelts comprising a lap belt and a shoulder harness extending diagonally across a seat occupant's chest. The shoulder harness limits the forward movement of a seat occupant's upper body in the event of a frontal impact.

In contrast, aircraft passenger seats are usually only equipped with a two-point seatbelt, which is a lap belt without shoulder harness. In the event of a high deceleration of an aircraft, the torso of a passenger is catapulted forward absent a shoulder harness. For passengers in angled seats, the forward direction of the aircraft is a diagonal direction relative to the seat. When the aircraft incurs a large longitudinal deceleration, inertia throws seat occupants of angled seats in the forward direction, which, with respect to the seat orientation, is a partially sideward direction for a seat occupant. The seat occupant may be thrown toward the adjacent seat located in the forward direction and hit a backrest, an armrest, or even the seat occupant of the adjacent seat.

### SUMMARY OF THE INVENTION

The object of the present invention is to provide an apparatus that improves the safety of aircraft seat occupants in angled seats in the event of a high longitudinal deceleration of the aircraft.

According to the invention, this object is achieved by an airbag arrangement in an armrest between angled seats that inflates an airbag cushion in the path of inertia of each seat occupant of an angled seat. The airbag may have a lamella structure to inflate to a cushioning curtain or wall with a stiffness that resists bending and folding. The airbag may alternatively be provided with wider channels to provide a thicker cushion.

Further details and advantages become apparent from the following description of various embodiments of the invention. The drawings are provided solely for illustrative purposes and are not intended to limit the invention to the details shown.

### BRIEF DESCRIPTION OF THE DRAWINGS

In the drawings,

FIG. 1 shows an exemplary schematic top view on an angled seating arrangement in an aircraft with airbags according to a first embodiment of the present invention;

FIG. 2 shows a perspective view on an angled seating arrangement implementing a second embodiment of the present invention;

FIG. 3 shows a perspective view corresponding to the view of FIG. 2 with a third embodiment of the present invention; and

FIG. 4 shows an exemplary schematic top view on an angled seating arrangement according to a fourth embodiment of the invention.

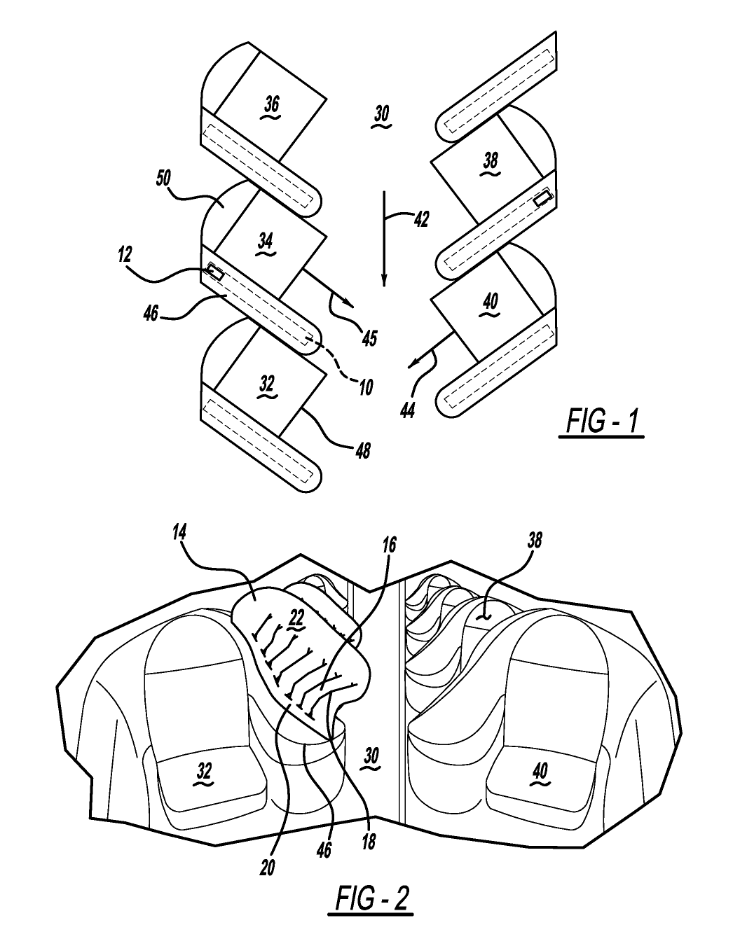

### DETAILED DESCRIPTION OF THE INVENTION

Figure shows a schematic view on an arrangement of angled aircraft seats in a bird's eye perspective.

A center aisle 30 of an aircraft is bordered on both sides by aircraft seats 32, 34, 36, 38, and 40. In this aircraft seating arrangement, the seats 32-40 are placed in such a pattern that a seat occupant does not face in a forward direction 42, but in a direction 44 or 45, respectively, at an angle of approximately 45° to 50° to the forward direction 42. The invention, however, is applicable to any angled seat arrangement in which the seat occupants are facing in a direction at an angle of approximately 20° to 160° to the forward direction 42. At seating angles smaller than 20° or larger than 160°, the direction in which the seat occupant face is not significantly different than a forward or backward direction so that airbags in armrests would protect such seat occupants in the event of a side impact rather than during a longitudinal acceleration or deceleration.

Two adjacent seats, for instance seats 32 and 34, are separated by an armrest 46. Seat 34 is located behind seat 32 with respect to the forward direction 42. Because of the angled arrangement of the seats 32 and 34, the sides of the seats 32 and 34 overlap to some extent. The armrest 46 extends from the back rest 50 of seat 34 along the right side of seat 34 facing seat 32 and along the left side of seat 32 facing seat 34 past the front edge 47 of seat 34 nearly to the front edge 48 of seat 32. In other arrangements, the armrest 36 may extend to the front edge 48 of seat 32 or farther to create areas of increased privacy for the seat occupants of seats 34 and 32.

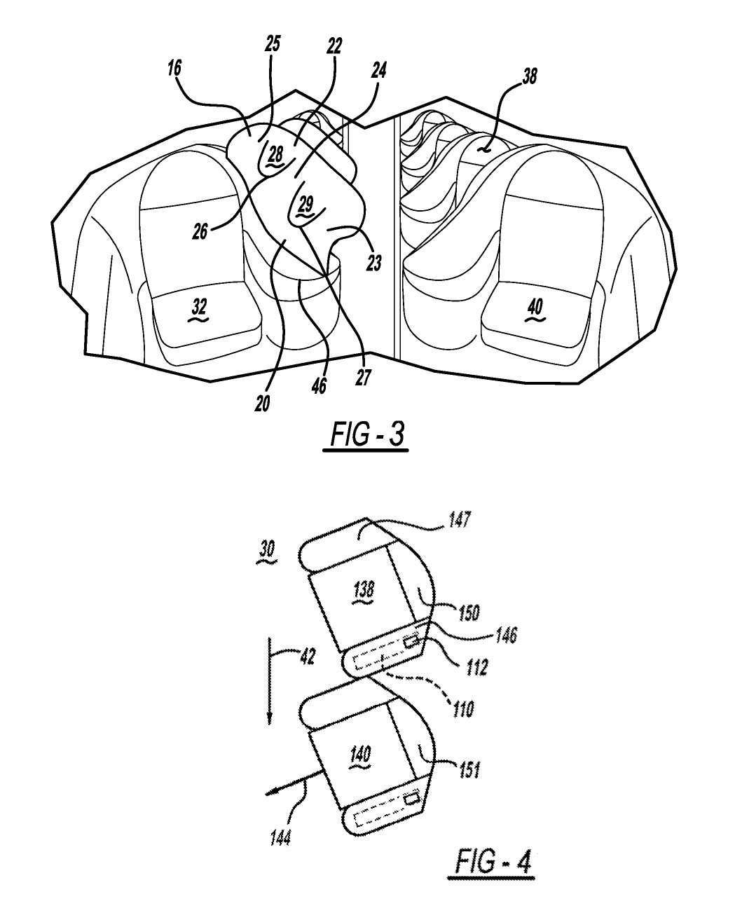

The armrest 36 accommodates an airbag arrangement 10 indicated with a broken line. The airbag arrangement 10 includes a gas generator 12 and an inflatable airbag 11 that may look like airbag 14 of FIG. 2 or like airbag 16 of FIG. 3. The airbag 11 is folded up or rolled up and hidden under a concealing armrest cover provided with a tear seam or a hinge to give way when the airbag 11 inflates upon deployment of the gas generator 12.

If an aircraft moving in the forward direction 42 incurs a sudden deceleration, for instance due to a frontal impact, seat occupants of the seats 32, 34, and 36 shown on the left side of the figure are not thrown in the direction 45 in which they face, but in the forward direction 42 toward the next seat ahead of them. For example, the seat occupant of seat 34 is urged by inertia toward seat 32. Likewise, the seat occupant of seat 38 will be thrown toward seat 40, not in the direction 44 in which the seat 38 faces. In the event of such a large deceleration, the gas generator 12 is electronically triggered and inflates the airbag 11.

The armrest cover opens under the inflation pressure and allows the airbag 11 to expand upward to a height that exceeds a typical seat occupant's top of the head. The airbag 11 lessens the impact when the seat occupant of seat 34 hits the armrest 46 and limits the forward movement of the seat occupant. The airbag arrangement 10 is configured to inflate the airbag 11 along most of the armrest 46. To the extent that the airbag overlaps with seat 32, it provides protection to the seat occupant of seat 32.

On the one hand, the airbag 11 reduces the risk that the seat occupant of seat 34 makes direct contact with the seat occupant of seat 32. On the other hand, the airbag 11 also reduces the risk of whiplash injuries when the sudden deceleration stops and the seat occupants are thrown in a backward direction opposite the forward direction 42.

Because airbag 11 serves to cushion a forward and backward impact during a course of events, it does typically not have any vents to release the inflation gas. The absence of vents extends the time during which the airbag 11 remains inflated and functional to at least several seconds.

Now referring to FIG. 2, the airbag 14 constitutes one exemplary embodiment of the airbag 11 in armrest 46. For illustrative purposes only, the seats 38 and 40 on the right side of FIG. 2 are depicted in a state before deployment of the respective airbags. Typically, all airbags 14 accommodated in armrests deploy at the same time.

The airbag 14 extends along the armrest 46 and features parallel lamellae. The lamellae 16 are formed by connecting the side of the airbag that faces seat 32 with the side of the airbag facing seat 34 with a plurality of seams or baffles 18. The seams or baffles 18 are generally alligned parallel to each other, thereby forming inflatable channels between them that form the lamellae 16. The lamellae 16 form open-ended tubes leading from an entry chamber 20 extending along the armrest 46 across a bottom portion of the airbag 14 to a top cushion 22 that also extends along the armrest 46 across a top portion of the airbag.

The top cushion 22 extends to a height above a typical seat occupant's head. For softening a head impact, the top cushion 22 has a larger volume than the entry chamber 20. By restricting relative movement between the connected sides of the airbag, the lamellae 16 provide a stiffness to the airbag 14 that resists lateral bending.

In FIG. 3, an alternative configuration in the form of airbag 16 is shown. The armrest 46 may accommodate the airbag 16 that features seams spaced apart at a larger distance than in FIG. 2. The seams 26 and 27 are U-shaped and form three channels 23, 24, and 25 leading to the top cushion 22. Between the channels 23 and 24, the seam 27 forms a pocket 29, and between the channels 24 and 25, the seam 26 forms another pocket 28.

As gas is released by the gas generator 12, it is led from the entry chamber 20 through the channels 23, 24, and 25 to the top cushion 22. From the top cushion 22, the gas fills the pockets 28 and 29. This order of inflation ensures that the airbag 16 reaches its full height at an early stage of inflation.

Due to the greater distance between the seams 26 and 27, the airbag 16 inflates to a larger thickness below the top cushion than the airbag 14 of FIG. 2. The inflated volume of airbag 16 is larger than the volume of airbag 14 and may provide more cushioning of an impact with the shoulder area of the seat occupant of seat 34. Like airbag 14 of FIG. 2, airbag 16 inflates to a height above a typical seat occupant's head. It extends along most of the armrest 46 for a large area of cushioning both in the forward direction 42 and backward direction of the aircraft.

The embodiments of airbags 14 and 16 of FIGS. 2 and 3 have in common that they build up a curtain-like or wall-like cushion between adjacent seats 34 and 32. The airbags 14 and 16 are configured to reduce injury to the seat occupant of seat 34 being thrown forward and to limit an intrusion into the seating area of seat 32. Conversely, when the aircraft no longer decelerates and the inertia urges the occupant of seat 32 backward, i.e. in a direction opposite to the forward direction 42, the airbag 14 or 16, respectively, also dampen an impact of the seat occupant of seat 32 moving backward.

Notably, the shown configurations of airbags 14 and 16 do not impede a seat occupant's egress from the respective seat 32 or 34. Because the airbags 14 and 16 inflate between adjacent seats, the seat occupants can move freely in the directions 45 or 44, respectively.

The shown airbags 14 and 16 are only exemplary for the seating arrangement of FIGS. 2 and 3, and different shapes are well within the scope of the present invention. The airbag shapes greatly depend on the configuration of the armrests between the seats, angle of the seats with respect to the forward direction 42, and on the overlap between adjacent seats. The same considerations made above for aircraft seats also apply for seats in other transportation vehicles with angled seating, such as trains, buses, or boats.

As evident from FIG. 4, an airbag arrangement according to the present invention does not require that two adjacent seats 138 and 140 share an armrest 146. In the illustrative example of FIG. 4, seat 140, which is located in front of seat 138 with respect to the forward direction 42, does not share armrest 146 with seat 138. Seat 138 likewise has one rear armrest 147 and one front armrest 146. In the embodiment shown, only the front armrest 146 accommodates an airbag 110 and a gas detonator 112. The airbag 110 extends approximately from the back rest 150 of seat 138 to the back rest 151 of seat 140 and is primarily configured to protect the seat occupant of seat 138. For illustrative purposes, the example of FIG. 4 shows the seats 138 and 140 arranged in a direction 144 at a greater angle with respect to the forward direction 42 than shown in the previous examples.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An airbag arrangement for a vehicle of the type having a first seat and a second seat, the first and second seats being adjacent to each other and facing in a seat direction at an angle to a forward direction of the vehicle between 20° and 160°, the first and second seat each having a backrest, the backrest of the second seat being located behind the backrest of the first seat with respect to the forward direction, with an armrest bordering the second seat on a side adjacent to the first seat, the armrest extending in the seat direction from the backrest of the second seat to at least the backrest of the first seat, the airbag arrangement comprising an airbag accommodated in or near the armrest and a gas generator, the gas generator being configured to inflate the airbag upon receiving a trigger signal to a height extending above the armrest.

2. The airbag arrangement of claim 1, further comprising that the airbag has an inflated state in which the height extends above the height of a typical seat occupant's head.

3. The airbag arrangement of claim 1, wherein the armrest is a shared armrest separating the first seat from the second seat and extending from the backrest of the second seat beyond a front edge of the second seat, further comprising that the airbag extends from the backrest of the second seat beyond the front edge of the second seat.

4. The airbag of claim 1, further comprising that the airbag and the gas generator are accommodated and concealed in the armrest.

5. The airbag arrangement of claim 2, further comprising that the airbag is configured to retain the inflated state for several seconds.

6. The airbag arrangement of claim 1, further comprising that the airbag has parallel lamellae leading from an entry chamber to a top cushion of the airbag.

7. The airbag arrangement of claim 6, wherein the top cushion is configured to make contact upon inflation with a head of a seat occupant thrown forward by inertia.

8. The airbag arrangement of claim 1, wherein the airbag has at least one U-shaped seam forming at least two channels and at least one pocket, the channels leading from an entry chamber to a top cushion that is in communication with the at least one pocket.

9. The airbag arrangement of claim 1, wherein the airbag extends along the armrest.

10. The airbag arrangement of claim 1, further comprising an armrest cover configured to give way to the airbag when the gas generator inflates the airbag.
